(19) United States
(12) Patent Application Publication
(10) Pub. No.: US 2007/0013694 A1
(43) Pub. Date: Jan. 18, 2007

(54) Optimized meshlet ordering

(75) Inventors: Julian Gold, Cambridge (GB); Thore Graepel, Cambridge (GB)

Correspondence Address: MICROSOFT CORPORATION;ATTN: PATENT GROUP DOCKETING DEPARTMENT, ONE MICROSOFT WAY, REDMOND, WA, 98052-6399, US

(73) Assignee: Microsoft Corporation, Redmond, WA (US)

(21) Appl. No.: 11/181,596

(22) Filed: Jul. 13, 2005

(51) Int. Cl. G06T 17/00

(52) U.S. Cl. 345/420

(57) ABSTRACT

A mesh model may be divided into nontrivial meshlets that together form the mesh model, where each meshlet has a single associated render state and some meshlets have different respective render states. Cost metrics are assigned to respective render state transitions, where each render state transition comprises a transition between a different pair of render states. A render state can be anything whose modification in a renderer incurs a slowdown or cost in the renderer. The cost metrics may be provided to an optimization algorithm that automatically determines an optimal order for rendering the meshlets. That is to say, an order for rendering the meshlets that optimizes the cost of changing render states when rendering the meshlets.

### BACKGROUND

FIG. 1 shows a system for rendering a 3D model 50. The 3D Model 50 is stored in memory 52 and has various data typical of a 3D model, such as a 3D mesh, lighting information, textures, or shader, etc. When the 3D model 50 is to be rendered for two dimensional display, the central processing unit (CPU) 54 passes the model 50 to a graphics subsystem 56. The graphics subsystem 56, for example a graphics card, hardware rendering device, etc. receives the model 50 and renders the model 50 in stages. Modern graphics subsystems usually have a pipeline architecture where different bits of graphics data are processed concurrently in respective stages of the pipeline. The graphics subsystem 56 in FIG. 1 has a simple generic rendering pipeline 58. Other graphics systems and cards will have different pipelines with different operational divisions. Data received, stored, executed, and/or processed by a graphics subsystem is usually stored in a local memory, called video RAM, or VRAM; in FIG. 1, VRAM 59. A pipeline may be partially programmable, for example a vertex shader stage, a geometry shader stage, or a pixel shader stage might each be user-programmable to a certain extent.

In FIG. 1, a render state 60 is stored in VRAM 59 and is used by various of the stages of the pipeline 58. The stages of a graphics pipeline will depend on a render state to perform their operations. A render state is a general term that can refer to a set of any number of dynamic conditions, parameters, settings, instructions (e.g. shader instructions), user data (e.g. textures), etc. that are set in or passed to the graphics subsystem 56, where they are stored and used for rendering. For purposes herein, a render state may be considered to refer to one or more conditions changeable within a graphic rendering system by input to the graphic rendering system. In graphics subsystem 56 a render state might include a particular texture in VRAM 59 and a stage of pipeline 58 might use the particular texture to perform pixel shading. Examples of render state conditions are discussed later with reference to FIG. 3.

A performance consideration with most graphics systems is data throughput. It is desirable to get data into a graphics system or renderer as quickly as possible. For example, data to be rendered typically passes from host memory (RAM) such as memory 52, through a host or system bus (e.g., bus 62), to a graphics device or system such as graphics subsystem 56. A graphics pipeline will perform suboptimally, becoming temporarily idle, if it cannot get data from host memory quickly enough. In other words, often there is one route for data from system RAM to VRAM, and that route is the same route that the majority of data takes through the host system. Although technology such as AGP (Accelerated Graphics Port) has improved data throughput performance, at the same time the amount of data applications are passing into graphics cards has increased. If a model being rendered has many different textures, then it can tax the bus to repeatedly pass different textures from a host's memory to the graphics system. This is of particular concern with three dimensional or volumetric textures. Depending on how the model is passed to the graphics rendering system, textures may be repeatedly passed in, replaced, passed in again, and so on, all of which consumes bus bandwidth. Generally, as the amount of data passed from host memory to a graphics system increases it becomes more likely that the bus carrying that data will be overloaded and the graphics system may become starved of data from time to time, thus decreasing its performance.

Another performance consideration is the overhead of changing the render state in the graphics pipeline. Many render state changes require the pipeline to flush before resuming rendering with the new render state. For example, a new texture may be used by multiple pipeline stages and therefore the pipeline will have to finish processing the data currently being handled by its stages before beginning to render with a new texture and an empty pipeline. As this occurs some of the stages of the pipeline will be idle. Other state changes such as material changes and alpha blending parameter changes can cause the same effect of stalling the pipeline. If a render state changes in a renderer frequently enough then the pipeline stages become increasingly idle and graphics are not drawn as quickly as might be possible.

Usually, model data is passed to a graphics card or graphics system in haphazard fashion without regard for render state changes. Some models are hand crafted based on an understanding of a particular pipeline in order to minimize state changes. However, this is a difficult and time consuming endeavor. Furthermore, hand crafted rendering order is usually done at a very high level (e.g., render car, then render driver) and fails to minimize render state changes at arbitrary divisions of a model.

Some graphics applications implement a “lazy state change” mechanism. When a render state parameter is required to be set, it is compared against an application's cached copy or knowledge of the current state. Only if the new parameter is different from that in the current render state will the change be passed on to the graphics hardware. However, this approach only avoids some redundant render state changes. In general, rendering order has not been automatically optimized to reduce the number of actual render state changes needed to render a model.

### SUMMARY

The following summary is included only to introduce some concepts discussed in the Detailed Description below. This summary is not comprehensive and is not intended to delineate the scope of protectable subject matter.

A mesh model may be divided into nontrivial meshlets that together form the mesh model, where each meshlet has a single associated render state and some meshlets have different respective render states. Cost metrics are assigned to respective render state transitions, where each render state transition comprises a transition between a different pair of render states. A render state can be anything whose modification in a renderer incurs a slowdown or cost in the renderer. The cost metrics may be provided to an optimization algorithm, for instance a dynamic programming algorithm that automatically determines an optimal order for rendering the meshlets. That is to say, an order for rendering the meshlets that optimizes the total cost of changing render states when rendering all of the meshlets.

Many of the attendant features will be more readily appreciated by referring to the following detailed description considered in connection with the accompanying drawings.

### DESCRIPTION OF THE DRAWINGS

FIG. 1 shows a system for rendering a 3D model.

FIG. 2 shows an overall approach for reducing render time.

FIG. 3 shows a model divided into meshlets M1 through M13, each to be rendered by one of 4 render states A through D.

FIG. 4 shows an example of render states that may serve as a basis for finding an optimal meshlet rendering order.

FIG. 5 shows a relationship diagram.

FIG. 6 shows how optimization can lead to a meshlet rendering order.

FIG. 7 shows a state diagram.

FIG. 8 shows a greedy algorithm embodiment.

FIGS. 9 and 10 show overdraw.

FIG. 11 shows a meshlet ordering algorithm.

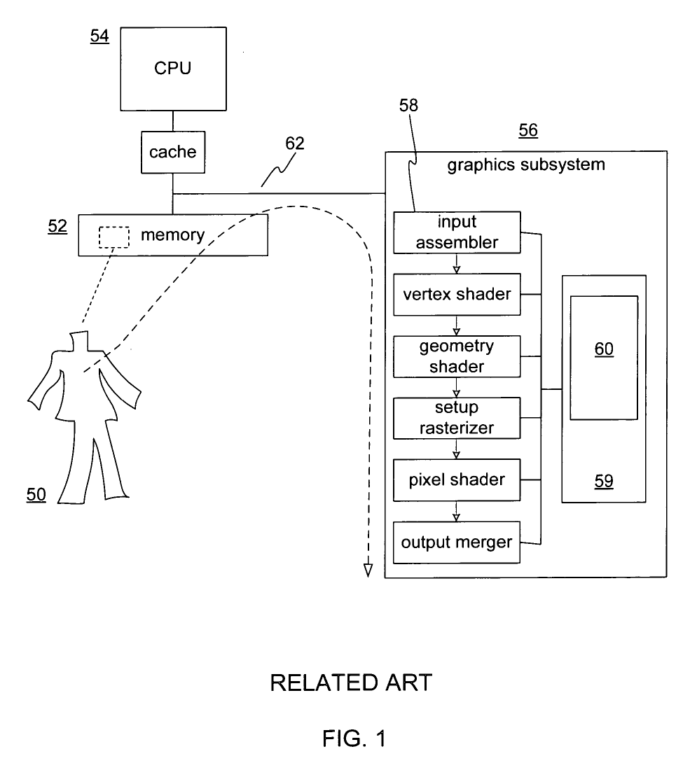

Like reference numerals are used to designate like parts in the accompanying Drawings.

### DETAILED DESCRIPTION

As discussed in the Background, when rendering a model with a graphics pipeline, each state change can cause some expense. It is desirable to minimize state changes within the renderer in order to improve throughput. Given two render states A and B, then when rendering different parts of a model a rendering sequence such as ABABABAB is the least optimal order of render changes. This sequence causes 7 state changes in the renderer and possibly 7 interruptions of flow in the renderer. A sequence such as AAAABBBB is a preferred order of rendering. This sequence only requires one state change and may significantly reduce the flow of data over a system bus to a renderer, particularly if the change between states A and B involves swapping a large amount of data such as three dimensional textures.

Discussed below are various techniques for minimizing changes in a rendering system's render state when rendering a 3D model. By modeling the state change problem to be amenable to optimization, changes in the render state can be minimized. By appropriately dividing a model into meshlets or submeshes, and by treating the meshlets or their render states as nodes and transitions between the nodes as having certain costs, any number of optimization algorithms can be used to obtain optimal or near-optimal render orders.

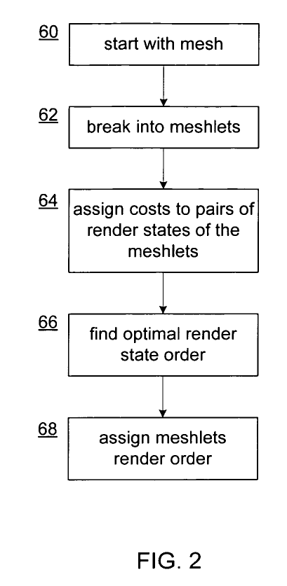

FIG. 2 shows an overall approach for reducing render time. Starting 60 with a mesh to be rendered, the mesh is broken up 62 into meshlets (smaller meshes). Costs are assigned 64 to pairs of render states of the meshlets. An optimal ordering of the render states is found 66 that minimizes their total cost. The meshlets are then assigned 68 a render order according to the optimal order of their render states.

Meshlets and Render States

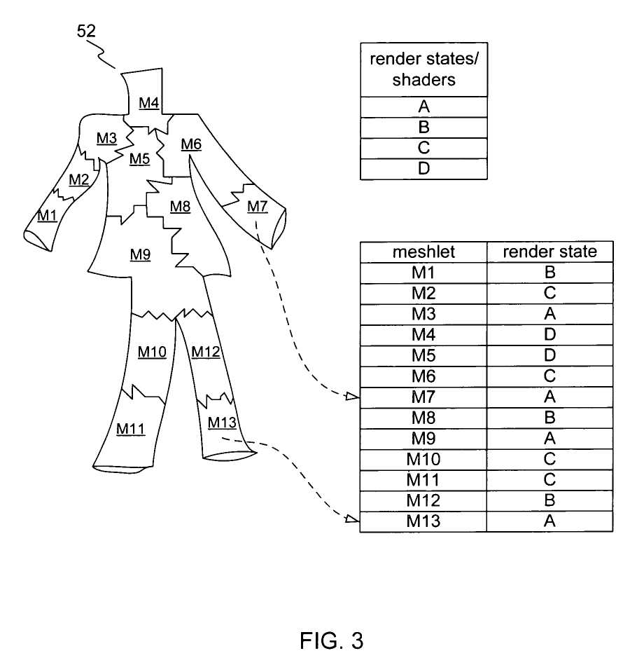

FIG. 3 shows model 52 divided into meshlets M1 through M13, each to be rendered by one of 4 render states A through D. A meshlet is a submesh of a mesh and is comprised of a computationally significant number of vertices. In other words, a meshlet is not a graphics primitive (in the render engine sense) but rather is itself a non-trivial mesh with possibly tens, hundreds, thousands, or more of vertices. Note that for purposes herein a mesh is treated the same as a 3D point cloud, and the term “mesh”, “submesh”, and “meshlet” are defined to refer to clouds of vertices as well as connected vertices. Furthermore, the embodiments discussed herein can be applied to 3 or more dimensions.

A mesh model can be divided into meshlets somewhat arbitrarily. However, how a mesh is divided into meshlets will usually be related to the render states associated with vertices of the model to be rendered. For example, in the case of a humanoid model, it is practical to start with large meshlets defined by common render states. For example, it may be known that a torso has one render state with a certain cloth texture and certain reflection properties. A helmet may be known to have another single render state with alpha blending activated, and so on.

Another approach for finding meshlets is to simply choose a limited number of render state conditions (some rendering devices have over 100 state conditions or properties) that are most expensive to change or that change most frequently, and find meshlets that can be rendered without changing these select render state conditions (until another meshlet is to be rendered), i.e., meshlets whose vertices commonly share the same settings of the select render state conditions. In this way, the overcall cost of render state changes will still be significantly reduced by minimizing the most expensive state changes while ignoring the less expensive and/or less common changes. In FIG. 3, render states A through D might be, respectively: alpha_blending=on, lighting=on; alpha_blending=on, lighting=off; alpha_blending=off, lighting=on; alpha_blending=off, lighting=off. Among other ways, meshlets for this approach can be found by repeatedly choosing a random seed vertex and continuing to recursively add neighboring vertices as long as the neighbors have the same render state as the seed vertex. This will find meshlets whose vertices share a same render state. In the example of FIG. 3, meshlets M1 through M13 would be found as the meshlets to be rendered by any one of the render states A through D.

It should be apparent from the discussion above that different disjoint meshlets can have the same render state. Referring again to the example in FIG. 3, meshlets M7 and M13 may have the same render state “A”. However, for purposes of finding a meshlet render order as discussed below, it may suffice to find an optimal (least costly) render state ordering, and then render meshlets accordingly. In the example of FIG. 3, if a render state order of BDAC is found to be optimal, then meshlets M1, M8, and M12 (render state B) would be rendered before other meshlets but in any order amongst themselves, meshlets M4 and M5 (render state D) would be rendered next, but in any order amongst themselves, and so on.

A model need not be completely divided into meshlets to improve its rendering efficiency. For example, if it were known in advance that certain areas of model 52 were the most time-consuming to render, then only these areas might be divided into meshlets and analyzed; other areas may be rendered in any arbitrary order. In other words, an entire model need not be analyzed and optimized, rather, any sub-portion or sub-portions of a mesh may be divided into meshlets and optimized.

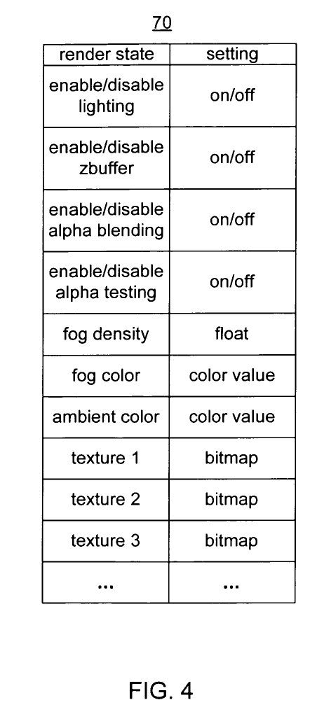

FIG. 4 shows an example of render states 70 that may serve as a basis for finding an optimal meshlet rendering order. In the case of an OpenGL rendering device, the render states 70 may be accessed or set using function calls. For instance “glEnable(GL_LIGHTING)” might enable lighting. Although the render states 70 shown in FIG. 4 are typical examples of what have been understood to be components of a rendering device's render state—components that may cause a pipeline flush, for example, it should be understood that any rendering drawing or rendering factor that rendering order is thought to be sensitive to may be used. Anything that is used to draw with can be considered part of a render state. Overdraw, or, redundant pixel rendering due to overlap, may also be considered to be a render state. Some devices have over 100 state settings, such as textures, whether to use alpha blending, and whether the z-buffer is on or off. Any one of these could potentially cause delays or stalls in the rendering pipeline. A render state can also be viewed generally as anything that causes the rendering pipeline to flush itself.

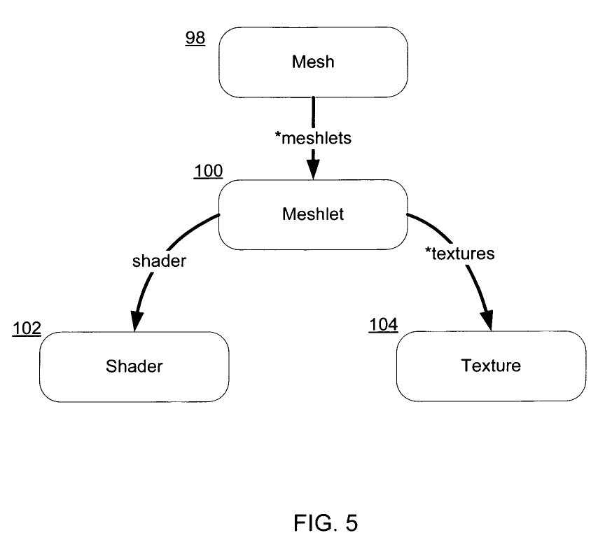

FIG. 5 shows a relationship diagram. The asterisks indicate a 1-to-many relationship. A mesh 98 may have many meshlets 100, and a meshlet 100 may have a shader 102 and many textures 104. Different meshlets 100 may share a shader 102 and/or one or more textures 104. In effect, a shader 102 and/or one or more textures 104 may together represent a render state. The diagram in FIG. 5 can be helpful in understanding the following discussion of render state optimization.

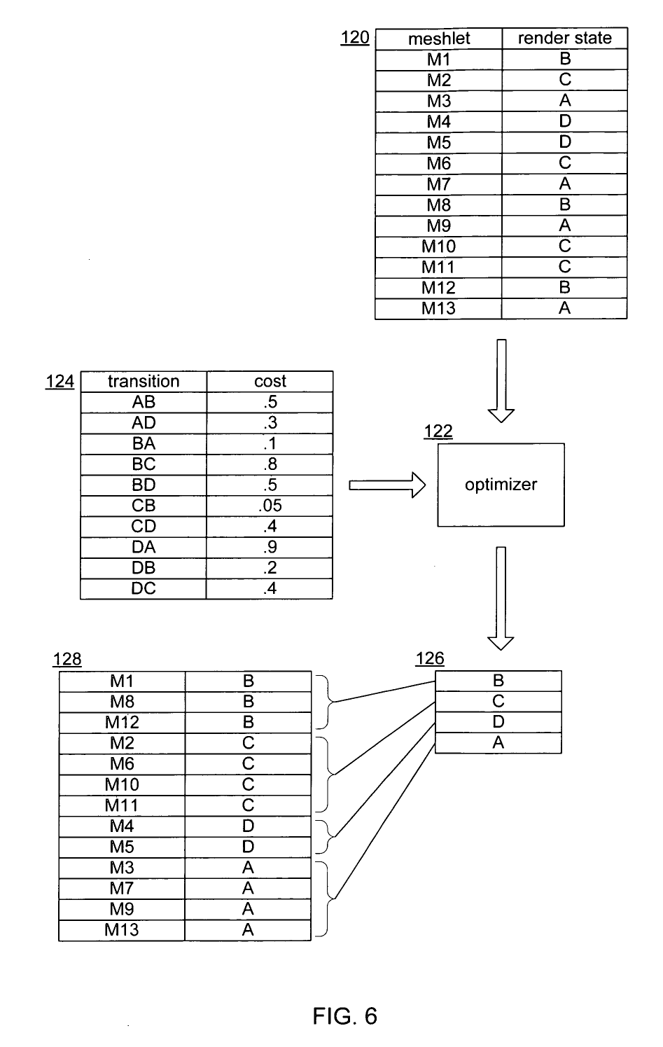

FIG. 6 shows how optimization can lead to a meshlet rendering order. Meshlets are associated with render states, for example in a table 120. An optimizer 122 receives the table 120 as well as costs 124 for transitions between the various render states. The optimizer 122 finds an order 126 of render states with an optimal cost of transitions therein. An order 128 for rendering meshlets is found by ordering the meshlets according to their corresponding render states in the optimal render order 126.

Optimization

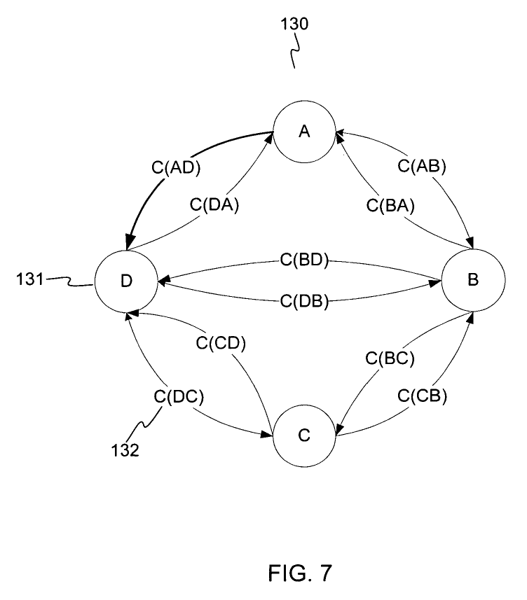

FIG. 7 shows a state diagram 130. A render state optimization solution may be implemented by modeling the render states as graph nodes 131 and the transitions between them as node traversals, where a traversal has a cost that represents a cost of changing from one render state to another. In other words, the problem of finding an order for visiting render states may be modeled as a traveling salesman problem where it is desirable to find a path or order of visiting all nodes one time while minimizing the sum of transition costs (render state changes) along that path or order. The initial node must also be determined. This is essentially a combinatorics problem that requires order N! calculations to find the perfect solution, however near perfect solutions can be found with order 2^{N} or less calculations. There are a large number of ways to solve traveling salesman type problems. For example, see a paper titled “Dynamic Programming Treatment of the Travelling [sic] Salesman Problem”, by Richard Bellman, July, 1961.

One aspect of modeling the problem is setting up a cost function 132. The cost function 132 maps particular node transitions to respective costs. For generality the cost function is assumed to be asymmetric. That is to say, the cost of traversing from node (render state) A to node B is not necessarily the same as the cost incurred from going to A from B. Referring to the example of FIG. 6, each transition will have a cost C(XY), where X and Y are any two nodes. The actual values of the cost function 132 are preferably determined empirically in advance. A cost of going from A to B to C to D, in the example of FIG. 6, would be C(AB)+C(BC)+C(CD), or 0.5+0.9+0.4.

The solution may be constrained in several ways. First, any meshlets that contain semi-transparent visuals are preferably drawn last in the order back-to-front (as determined by distance from the viewpoint) to appear correct visually. Second all other meshlets in the order are preferably drawn front-to-back. This reduces the cost of overdraw; the cost of setting the same pixel multiple times, (z-buffering will cull the redundant sets with this draw order).

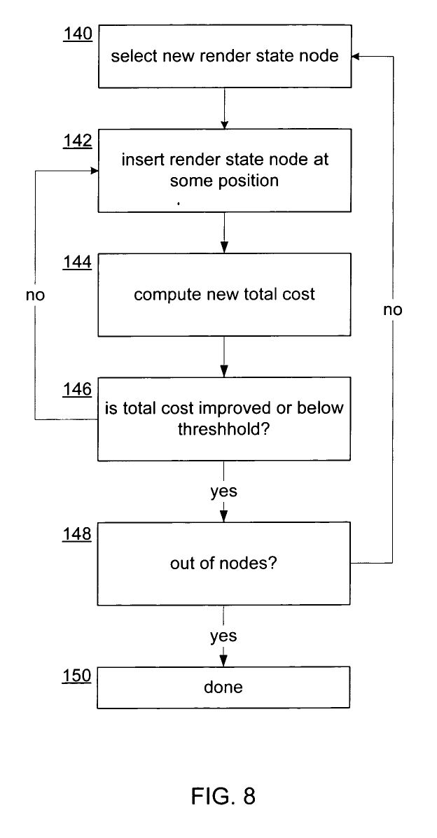

Whether constrained or not, because the problem has been framed as a dynamic optimization problem, other dynamic programming techniques may be used. FIG. 8 shows a greedy algorithm embodiment. In this embodiment, starting with all render state nodes, a new render state node is selected 140. The node is inserted 142 at some ordered position, possibly randomly chosen. The total cost of the ordering according to the insertion 142 is computed 144. If 146 the total cost is improved, and assuming that the process is not 148 out of nodes, then another node is selected 140, and so on. If 146 the total cost is not improved by the insertion 142 then the node is reinserted 142 at some other position in the ordering, the cost is recomputed 144, and so on. The process is done 150 when all nodes have been placed. This process may produce a sub-optimal result but may complete more quickly.

Finding an optimal meshlet render order based on minimizing costs related to render state changes may not always be the fastest way to render a model. It is possible that an order for rendering meshlets may create needless computing in the form of overdraw. Therefore, if overdraw is expected to be a consideration for a particular model, it may be helpful to include a heuristic for determining whether the cost savings of the render order optimization is outweighed by an overdraw penalty. A heuristic may be used to determine the amount of overdraw in a scene and therefore the cost of redundant pixel operations. If the overdraw penalty is smaller than the cost of rendering meshlets in the optimal order then the optimal order is used. Otherwise, the meshlets are drawn in order from front to back.

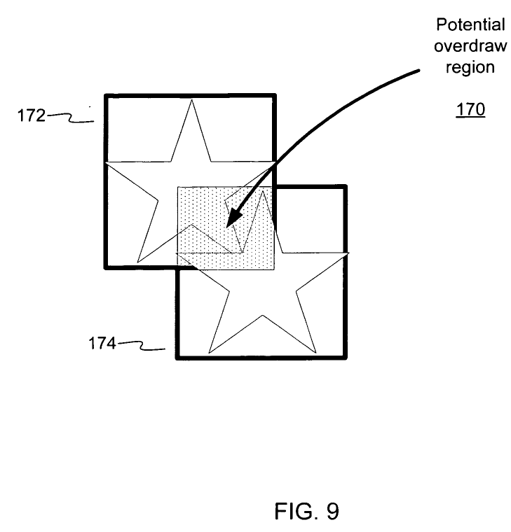

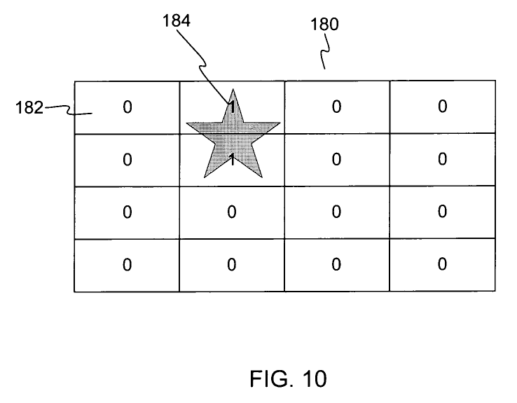

FIGS. 9 and 10 show overdraw. Several heuristics may be used to estimate overdraw costs. Although in principle it is possible to maintain a count of the number of times each pixel is referenced during the rendering process, this is infeasible due to memory and time considerations. Instead, a first approach is to estimate the amount of overdraw based on the overlap area of bounding rectangles around the meshlets in screen coordinates, as shown in FIG. 9. In FIG. 9, region 170 is an estimated overlap of two meshlet projections 172 and 174. The area of region 170 approximates how much the corresponding meshlets overlap.

A second approach is to maintain a coarse grid of n×m cells where n<<screen width and m<<screen height. FIG. 10 shows a grid 180 with cells 182. A cell counter is incremented if a meshlet such as meshlet 184 intersects a cell 182 in screen space. The overdraw heuristic is then determined by the Herfindahl Measure for the data:

$$H = {\sum }_{i = 1}^{n} {\sum }_{j = 1}^{m} {( \frac{{c}_{ij}}{M} )}^{2} ,$$

where M is the number of meshlets drawn and cᵢⱼ is the count in the (i,j)th cell. Variable H is in the range [1/M,1], where the lower bound indicates little overdraw and the upper bound indicates high overdraw. The total cost of overdraw can then be approximated by: C_{overdraw}=k_{overdraw}·H, where k is determined empirically.

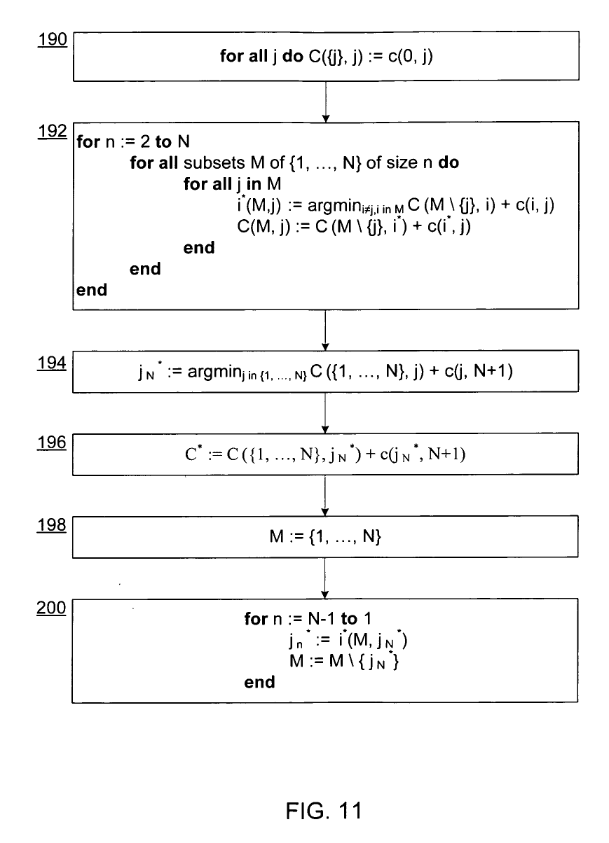

FIG. 11 shows another meshlet ordering algorithm. Assuming that there are N meshlets numbered 1, . . . , N, and assuming that a dummy initial state 0 and terminal state N+1, the rendering process starts in the initial state 0 and terminates in the terminal state N+1. As discussed above there is a cost function c that assigns non-negative cost to state transitions, i.e., c(i, j) is the cost associated with a transition from meshlet i to meshlet j. The goal is to find an optimal rendering schedule (0, j₁, . . . , j_{N}, N+1) with costs C(j₁, . . . , j_{N})=c(0, j₁)+c(j₁, j₂)+ . . . +c(j_{N-1}, j_{N})+c(j_{N}, j_{N+1}). As mentioned previously, finding the optimal route could require calculating and comparing the costs of up to N! different routes. However, these routes have many sub-routes in common whose costs should not be evaluated more than once. These considerations lead to the following dynamic programming algorithm. Define M to be a subset of the set {1, . . . , N} of meshlets. Define C(M, j), j in M, to be the cost of the shortest schedule that starts from 0 renders all meshlets in S and ends up rendering meshlet j. Then the algorithm proceeds as in FIG. 11.

In step 190, a table of costs is initialized for every meshlet j, with C({j}, j) representing the costs of starting at the initial state 0 and subsequently rendering meshlet j. In step 192 the first for-loop runs over the length n of sub-schedules to be examined. The next for-loop runs over subsets M of size n. For each subset M the minimal cost C(M, j) of starting with 0, rendering all the meshlets in M, and finishing with meshlet j, is determined in a recursive way from the table previously built up for subsets of size n−1. The cost C(M, j) of the best schedule for M ending in j is calculated by finding the best meshlet i* so as to minimize the cost C(M\{j}, i*) for the subset M without meshlet j, increased by the cost c(i*, j) of rendering meshlet j after the best final meshlet i* for M\{j}. Step 194 finds the final meshlet j_{N}* of the optimal schedule and step 196 finds the optimal total costs C*. Steps 198 and 200 read out the optimal route from the tables built up in step 192.

The computational complexity of the algorithm in FIG. 111 is O(N²2^{N}). There are 2^{N} different subsets of the set {1, . . . , N}. For each of them O(N) numbers are stored, one for each meshlet j being rendered last. Filling each of the N2^{N} entries of the table requires O(N) operations. The readout operation in step 200 requires another O(N) operations.

Actual costs of state operations or transitions can be determined empirically, or from hardware information provide by a video card manufacturer. Bottlenecks/costs in a render pipeline can be discovered using a number of canonical tests, e.g., drawing a sphere, drawing an object with lots of textures, drawing lots of objects with one texture, drawing lots of objects with lots of textures, drawing lots of objects a pixel in size, drawing lots of objects stacked up against each other, and so on. Such a benchmark suite can produce coefficients that can then be used to determine constraints or costs in the system.

Although limits are difficult to determine, 16 meshlets is an example of the size of an upper limit for the dynamic programming algorithm, which would take 2⁴⁴ tests using the brute force N! approach. The dynamic programming algorithm uses 2²⁴ tests, which is very practical. Optimization of 10-12 meshlets can be done very quickly. If it is desirable to order more meshlets then an approximating algorithm can be used, perhaps pushing the upper limit to 30 or more meshlets. This may require locally changing some initial ordering. Some initial ordering based on some heuristic would be found, and then the algorithm would start swapping meshlets and try for local improvements. Given the likelihood of future hardware and algorithm advances, these limits are mentioned only to give a general sense of feasibility.

Again, it should be noted that once the problem has been formulated as an optimization problem, any past or future optimization algorithm may be used.

Various optimization approaches discussed above can be put to practical use in a number of ways. Model authoring programs such as Maya or 3D Studio Max can be provided with a plug-in. Users can use the plug-in to export some game data or model data. The plug-in will look at the data being exported and generate optimization information either as metadata within the exported data or as separate data with pointers into the exported data. The optimization can then be used at render time using a library that implements meshlets as discussed above. Optimization can also be done offline. Rendering occurs at the application and above the level of compiled computer graphic primitives. When data comes out of an art package it is passed to an optimization system that saves the data in optimized form such that it can be loaded by a game or other rendering system. Optimization could also occur at the front end of a renderer, but this may be too slow for dynamic rendering.

### Other Embodiments

If through heuristic analysis it has been decided to sort meshlets because overdraw will dominate the cost of rendering the meshlets, then the sorting may be based on the z-coordinate of the meshlet in screen coordinates. However, since objects have non-zero extents, there can well be overlap in the z extents of objects resulting in overlapping meshlets being in the same sort bucket. Objects in these buckets can be rendered in any order; however, provided there are not too many objects in the bucket, then a dynamic programming sorting algorithm can be used to sort objects within the bucket into an effective draw order.

### CONCLUSION

Those skilled in the art will realize that storage devices utilized to store program instructions can be distributed across a network. For example a remote computer may store an example of the process described as software. A local or terminal computer may access the remote computer and download a part or all of the software to run the program. Alternatively the local computer may download pieces of the software as needed, or distributively process by executing some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like. Furthermore, those skilled in the art will also appreciate that no further explanation is needed for embodiments discussed to be implemented on devices other than computers. All of the embodiments and features discussed above can be realized in the form of information stored in volatile or non-volatile computer readable medium. This is deemed to include at least media such as CD-ROM, magnetic media, flash ROM, etc., storing machine executable instructions, or source code, or any other information that can be used to enable a computing device to perform the various embodiments. This is also deemed to include at least volatile memory such as RAM storing information such as CPU instructions during execution of a program carrying out an embodiment.

Those skilled in the art will also realize that a variety of well-known types of computing systems, networks, and hardware devices, such as workstations, personal computers, PDAs, mobile devices, and so on, may be used to implement embodiments discussed herein. Such systems and their typical components including CPUs, memory, storage devices, network interfaces, operating systems, application programs, etc. are well known and detailed description thereof is unnecessary and omitted.

1. A volatile or non-volatile computer-readable medium storing information usable by a device to perform a process of determining a sequential order for rendering submeshes of a mesh model where the submeshes are capable of being rendered in different sequential orders, where a total cost of rendering the mesh model depends upon a sequential order in which the submeshes are to be rendered, the process comprising:
performing a constrained optimization calculation that uses predetermined costs of transitions between rendering of the submeshes to determine an optimal sequential order for rendering the submeshes.

2. A volatile or non-volatile computer-readable medium according to claim 1, wherein the predetermined costs of transitions correspond to costs of changing rendering states of a graphics pipeline.

3. A volatile or non-volatile computer-readable medium according to claim 1, wherein the optimization calculation comprises a greedy optimization algorithm and a potential ordering of a submesh is adapted or rejected by determining whether the potential ordering improves the total cost.

4. A volatile or non-volatile computer-readable medium according to claim 1, wherein the optimization calculation comprises a dynamic programming algorithm.

5. A volatile or non-volatile computer-readable medium according to claim 1, wherein the constrained optimization calculation is constrained to arrange the submeshes in a front-to-back order.

6. A volatile or non-volatile computer-readable medium according to claim 1, wherein the mesh model has a plurality of render states and each of the submeshes is to be rendered with only one of any of the render states.

7. A volatile or non-volatile computer-readable medium according to claim 6, wherein the costs of transitions correspond to costs of a graphics pipeline transitioning between the render states.

8. A computing device performing or configured to perform a method, the method comprising:
dividing a mesh model into nontrivial meshlets that together form the mesh model, where each meshlet has a single associated render state and some meshlets have different respective render states;
assigning cost metrics to respective render state transitions, where each render state transition comprises a transition between a different pair of render states; and
providing the cost metrics to a dynamic programming algorithm to automatically determine an optimal or near-optimal order of the meshlets.

9. A computing device according to claim 8, wherein a constrained optimization calculation uses the cost metrics to automatically determine the order of the meshlets.

10. A computing device according to claim 9, wherein the optimization calculation determines the order of the meshlets to minimize a total cost of changing the render states to render the mesh model.

11. A computing device according to claim 9, wherein the optimization calculation comprises a dynamic programming algorithm.

12. A computing device according to claim 8, wherein in the determined order of the meshlets runs of meshlets having a common render state are ordered to minimize a cost of overdrawing pixels.

13. A computing device according to claim 8, wherein the render states correspond to respective shaders.

14. A computing device according to claim 8, wherein the process further comprises automatically determining an overdraw cost for rendering the meshlets in the determined order.

15. A computing device according to claim 14, wherein the process further comprises using the overdraw cost to automatically determine whether to render the meshlets according to the determined order or whether to render the meshlets according to an optimized front-to-back order.

16. A computing device according to claim 14, wherein the overdraw cost is computed either using overlap of rectangles that bound the meshlets, or by counting intersections of meshlets with screen space areas.

17. A computer-readable medium storing information for performing a process, the process comprising:
reading a mesh model and identifying submeshes of the mesh model, where submeshes are divided according to render states for rendering the mesh model; and
performing a dynamic programming calculation that finds an optimal order for rendering all of the submeshes based on predefined costs of rendering different possible submesh pairs.

18. A computer-readable medium according to claim 18, wherein the dynamic programming calculation is constrained by a cost of overdrawing the submeshes.

19. A computer-readable medium according to claim 18, further comprising storing the mesh model and storing with it information indicating the optimal order.

20. A computer-readable medium according to claim 18, further comprising, within the optimal order, sorting submeshes with a same render state to minimize overdraw.
